(19) United States
(12) Patent Application Publication
(10) Pub. No.: US 2016/0034944 A1
(43) Pub. Date: Feb. 4, 2016

(54) INTEGRATED MOBILE LISTING SERVICE

(71) Applicants: Oren Raab, Posctcoe (IL); Suresh Karuppuchamy, Madurai (IN); Karpagam Balasubramaniam, San Jose, CA (US); Nithya Chellam, Bangalore (IN); Divya Manohar, San Jose, CA (US)

(72) Inventors: Oren Raab, Posctcoe (IL); Suresh Karuppuchamy, Madurai (IN); Karpagam Balasubramaniam, San Jose, CA (US); Nithya Chellam, Bangalore (IN); Divya Manohar, San Jose, CA (US)

(21) Appl. No.: 14/450,796

(22) Filed: Aug. 4, 2014

(51) Int. Cl. G06Q 30/02; G06Q 10/08; G06Q 20/32

(52) U.S. Cl. CPC G06Q 30/0241; G06Q 20/322; G06Q 10/083; G06Q 40/02

(57) ABSTRACT

An Integrated Mobile Listing Service vehicle is self-contained and equipped with technical facilities for listing, marketing, packing, shipping and completing online sales. A seller can summon, or meet the vehicle on a scheduled route . A seller need provide nothing more than the item to realize a sale. A system comprises a User Interface module for controlling an imaging module, a marketing and listing module, a fulfillment center module and a banking center module, an imaging module for capturing images of an item for online sale and providing input to marketing and listing module, a marketing and listing module for generating a complete online listing from the captured images of the item and providing input to a fulfillment center module, a fulfillment center module for packing, shipping and tracking the item, and providing input to a banking center module, and a banking center module for transferring payment funds.

### TECHNICAL FIELD

The present application relates generally to the technical field of commercial uses of search algorithms implemented on a computer and, in one example embodiment, to methods and systems to enable navigation of data items based on aspect Integrated Mobile Listing Service.

### BACKGROUND

Many potential online sellers of goods cannot realize the advantages of internet sales opportunities for lack of technical devices (computers, cameras, internet connectivity), marketing knowledge, transportation, and/or access to shipping and banking facilities. Thus, there is a need for convenient on demand assisted internet marketing and sales support.

### BRIEF DESCRIPTION OF THE DRAWINGS

Some embodiments are illustrated by way of example and not limitation in the figures of the accompanying drawings in which:

FIG. 1 is a block diagram depicting a system suitable for Integrated Mobile Listing Service, according to some example embodiments;

FIG. 2 is a block diagram illustrating a network-based publication system for processing a search query, and presenting search results (e.g., marketplace listings), as described more fully herein.

FIG. 3 is a high level block diagram illustrating components for Integrated Mobile Listing Service, according to some example embodiments;

FIG. 4 is a high level overview flow chart of Integrated Mobile Listing Service, according to some example embodiments;

FIG. 5 is a block diagram illustrating components of a machine, according to some example embodiments, able to read instructions from a machine-readable medium and perform any one or more of the methodologies for Integrated Mobile Listing Service discussed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Example methods and systems for Integrated Mobile Listing Service are described. In the following description, for purposes of explanation, numerous specific details are set forth in order to provide a thorough understanding of example embodiments. It will be evident, however, to one skilled in the art that the present invention may be practiced without these specific details.

Many areas of the world do not have sufficient infrastructure to support online sale of goods. Participation in online selling is also inhibited by many other obstacles such as inaccessibility or inability to operate computers, unmet needs for internet connectivity, physical disability, lack of transportation, need for listing assistance, expense of high quality camera and video equipment, and so on. The profit and advantages of online selling are not attainable for sellers in remote or undeveloped areas, as well as urbanites who are computer illiterate, need assistance pricing and selling their items, or are simply pressed for time in today's environment.

For example, on the entire continent of Africa, there are approximately 579 active online sellers, or 3780% less active sellers than in the United States alone. 90% of those sellers are located in Egypt and South Africa. The remaining 10% reside in African countries with an average of 5 active sellers. Many people in these underdeveloped or remote areas could improve their conditions by selling fair trade goods, artisanal products or commercial items. However, these potential sellers often live in remote villages and lack even basic infrastructure for internet access, technical equipment and expertise for creating online listings or completing the sales, or both. In other scenarios, buyers in developed nations may be aged, homebound, or unable to sell online without listing, marketing, or technical assistance.

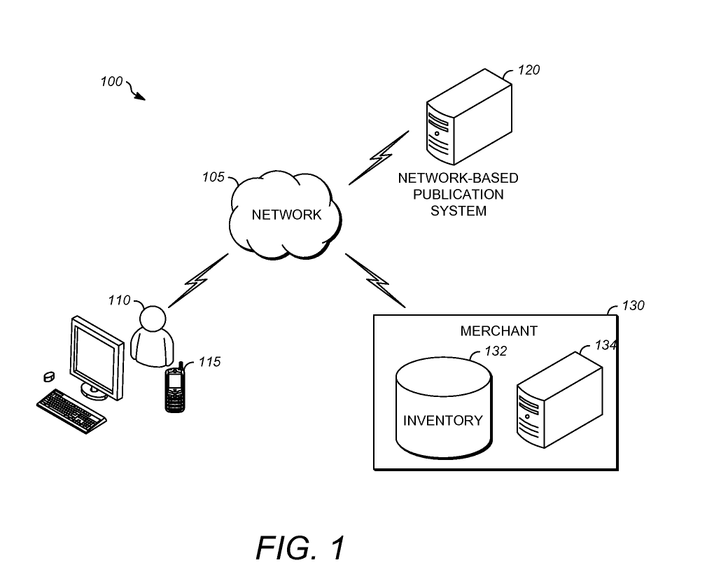

An Integrated Mobile Listing Service is disclosed in FIGS. 1-5. An Integrated Mobile Listing Service vehicle is self-contained and equipped with technical facilities for listing, marketing, completing online sales, packing, shipping and processing payment transactions. Everything needed to create a quality online listing is integrated and mobile, such that a seller can summon the vehicle by internet, phone or mobile application, or meet the vehicle at locations on a regularly designate route or accessible event.

In some embodiments, an Integrated Mobile Listing Service representative arrives in the system vehicle, accepts the seller's item(s) and generates a complete listing for the seller using the integrated technical components. In other embodiments, a stationary (i.e., parked) vehicle or a kiosk may be offered whereby the seller can place an item in an intake port, or receptacle, while the technical components of the system are operated remotely by a system representative or the seller himself using a mobile application.

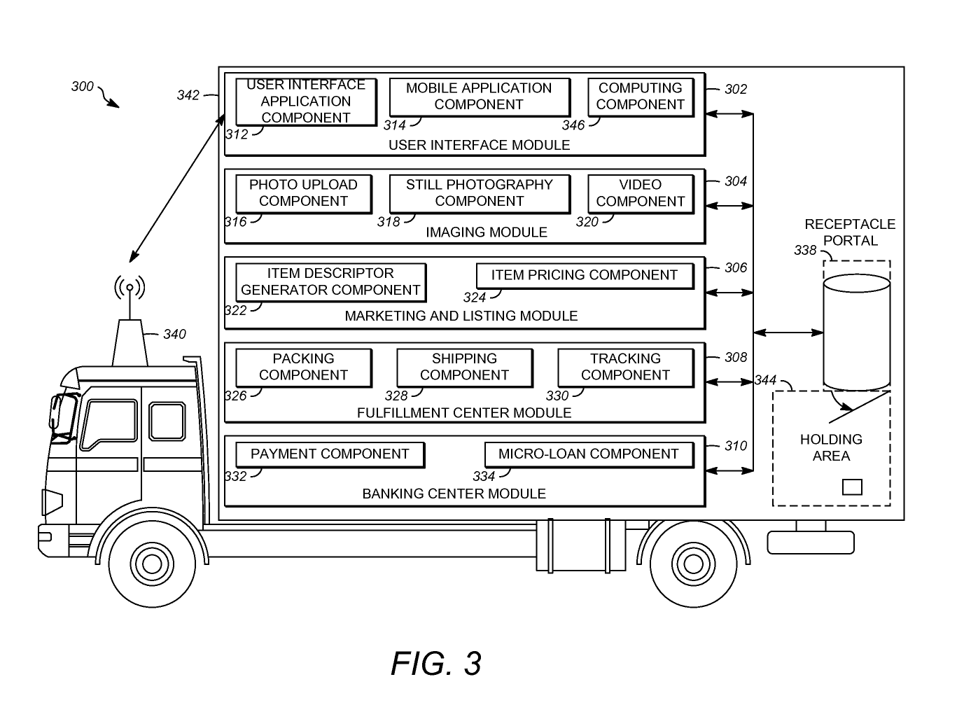

The seller's listing is generated by integrated high end photography, listing and marketing, fulfillment center and banking center module detailed in FIG. 3. Payments to the seller are deposited electronically or made in person by the Integrated Mobile Listing Service representative at a next visit, in a local currency.

FIG. 1 is a network diagram illustrating a network environment suitable for Integrated Mobile Listing Service, according to some example embodiments. FIG. 1 shows a block diagram depicting a system 100 for identifying items and offering services and benefits to users. The system 100 can include a user 110, a network-based publication system 120 with a search engine, and one or more merchants 130 (and merchant systems). In an example, the user 110 can connect to the network-based publication system 120 via a client computing device 115 (e.g., desktop, laptop, smart phone, Personal Digital Assistant (PDA), or similar electronic device capable of some form of data connectivity) and network 105. The user 100 may be an online seller or Integrated Mobile Listing Service representative. The network-based publication system 120 will receive and process a query from the user's client computing device 115, and return search results in a search results page or similar User interface (UI), typically with the most relevant results listed first (or, at the top) and may offer subscriptions and subscription benefits related to displayed search results.

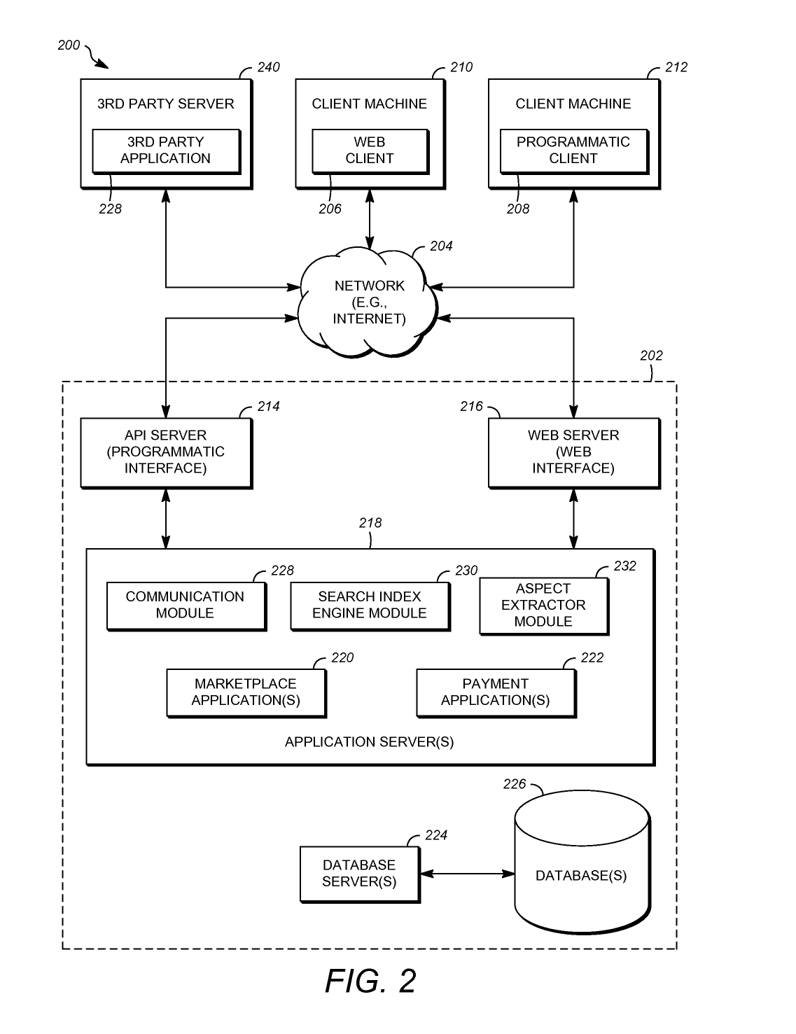

In an example embodiment, the merchant 130 can operate computer systems, such as an inventory system 132 or a Point of Sale (POS) system 134. The network-based publication system 120 can interact with any of the systems used by merchant 130 for operation of the merchant's retail or service business. In an example, the network-based publication system 120 can work with both POS system 134 and inventory system 132 to obtain access to inventory available at individual retail locations operated by the merchant. This inventory information can be used in both generating product or service listings, and selecting and ordering search results served by the network-based publication system 120. An example network-based publication system 120 is detailed below in FIG. 2.

FIG. 2 is a block diagram illustrating a network-based publication system 200 for processing a search query, presenting search results (e.g., marketplace listings), and offering subscription services and benefits as described more fully herein. The block diagram depicts a network-based publication system 200 (in the exemplary form of a client-server system), within which an example embodiment of Integrated Mobile Listing Service can be deployed. A networked system 200 is shown, in the example form of a network-based location-aware publication, advertisement, or marketplace system, that provides server-side functionality, via a network 204 (e.g., the Internet or WAN) to one or more client machines 210, 212. FIG. 2 illustrates, for example, a web client 206 (e.g., a browser, such as the Internet Explorer browser developed by Microsoft Corporation of Redmond, Wash.) and a programmatic client 208 executing on respective client machines 210 and 212. In an example, the client machines 210 and 212 can be in the form of a mobile device, such as client computing device 115.

An Application Programming Interface (API) server 214 and a web server 216 are coupled to, and provide programmatic and web interfaces respectively to, one or more application servers 218. The application servers 218 host one or more marketplace application modules 220 (in certain examples, these can also include commerce modules, advertising modules, and marketplace modules, to name a few), payment applications modules 222, search engine index modules 230 communication modules 228, and Aspect Extractor modules 232. The application servers 218 are, in turn, shown to be coupled to one or more database servers 224 that facilitate access to one or more databases 226. In some examples, the application server 218 can access the databases 226 directly without the need for a database server 224.

The marketplace application modules 220, comprising publication functionality, may provide a number of publication and search functions and services to users that access the networked system 200. The payment applications modules 222 may likewise provide a number of payment services and offer functions to users. The payment applications modules 222 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various marketplace application modules 220, within retail locations, or within external online retail venues. The payment application modules 222 may also be configured to present or facilitate a redemption of offers, to a user during checkout (or prior to checkout, while the user is still actively shopping). The payment application modules 222 may provide dynamic context sensitive offers (e.g., coupons or immediate discount deals on targeted products or services) to users of the networked system 200. The payment applications modules 222 can be configured to use all of the various communication mechanisms provided by the networked system 200 to present offer options to users. The offer options can be personalized based on current location, time of day, user profile data, past purchase history, or recent physical or online behaviors recorded by the network-based system 200, among other things (e.g., context information). While the marketplace applications modules 220 and payment applications modules 222 are shown in FIG. 2 to all form part of the networked system 200, it will be appreciated that, in alternative embodiments, the payment applications modules 222 may form part of a payment service that is separate and distinct from the networked system 200. Additionally, in some examples, the payment applciations modules 222 may be part of the payment service or may form an offer generation service separate and distinct from the networked system 200.

Further, while the system 200 shown in FIG. 2 employs a client-server architecture, the embodiments of the present invention are of course not limited to such an architecture, and could equally well find application in a distributed, or peer-to-peer, architecture system, for example. The various marketplace application modules 220 and payment applications modules 222 could also be implemented as standalone systems or software programs, which do not necessarily have networking capabilities.

The web client 206 accesses the various marketplace applications modules 220 and payment applications modules 222 via the web interface supported by the web server 316. Similarly, the programmatic client 208 accesses the various services and functions provided by the marketplace application modules 220 and payment applications modules 222 via the programmatic interface provided by the API server 214. The programmatic client 208 may, for example, be a smartphone application that enables users to communicate search queries to the system 200 while leveraging user profile data and current location information provided by the smartphone or accessed over the network 200. FIG. 2 also illustrates a third-party application 228, executing on a third-party server machine 240, as having programmatic access to the networked system 200 via the programmatic interface provided by the API server 214. For example, the third-party application 228 may, utilizing information retrieved from the networked system 202, support one or more features or functions on a website hosted by the third party. The third-party website may, for example, provide one or more promotional, marketplace or payment functions that are supported by the relevant applications of the networked system 200. Additionally, the third-party website may provide merchants with access to the payment applications modules 222 for configuration purposes. In certain examples, merchants can use programmatic interfaces provided by the API server 214 to develop and implement rules-based pricing schemes that can be implemented via the marketplace application modules 220, and payment applications modules 222.

FIG. 3 is a high level block diagram illustrating components for Integrated Mobile Listing Service 300, according to some example embodiments. The Integrated Mobile Listing Service comprises a vehicle 342 or kiosk (kiosk) having a User Interface (UI) Module 302, an Imaging Module 304, a Listing and Marketing Module 306, a Fulfilment Center Module 308, and a Banking Center Module 310. Each integrated module 302-310 operates to perform one or more functions a turnkey online listing and delivery process. The seller need provide nothing more than the item itself to realize listing, marketing, delivery, and payment.

The UI Module 302 provides a flexible interface for direct or remote control of the system 300. The UI Module 302 may comprise a Universal Serial Bus (USB) port, Ethernet connectivity, wireless network transceiver, and modem to support online sales UI Application 312 and Mobile Application 314 module components. The UI Module 302 is connectively coupled to the other system modules 304-310, receptacle portal 338 and wireless transceiver 340 such that a user can operate all of the other modularized system components 314-334 from a computing component 346. The computing component 346 may comprise any type of laptop, desktop, tablet, Personal Data Assistant, or other device providing computer functionality.

The UI Application 312 and Mobile Application 314 provide a system interface for allowing users to summon an Integrated Mobile Listing Service vehicle 342 to a residence, workplace, or other location in a transportation networked arrangement. The Integrated Mobile Listing Service vehicle 342 may serve urban, rural and remote routes. Global Positioning System (GPS) routes and vehicle locations may published for notifying sellers when the vehicle is in their area and providing the ability for sellers to make an appointment or immediately summon the system vehicle 342. Alternately, published routes provide for sellers who do not have any access to internet or phone to access the system by way of attending a prescheduled stop on the route of the vehicle.

The Imaging Module 304 is configured to control an upload component 316, a still photography component 318, and a video component 320 of the Imagining Module. The upload component 316 may be operated to upload an item photograph from a computer, camera, mobile phone, or other photographic device to be provided to the Marketing and Listing Module 306 for generating an online ready item listing.

The still photography component 318 may be fitted with, for example, high quality single lens reflex (SLR), High Definition (HD) and 3 dimensional (3D) still cameras. These still cameras may be controlled by the user application 312 and mobile application 314 components of the UI Module 312. In some embodiments, the still cameras are integrated to the receptacle portal 338. The receptacle portal 338 may thus serve as a directly or remotely operable photo booth as well as an item intake mechanism.

A seller or Integrated Mobile Listing Service representative can place an item in the receptacle portal 338, where high quality listing images can be captured. In some embodiments, the item is dropped into a holding area 344 for packing and shipping by the Fulfillment Center Module 308 after completion of the photographic operations. The video component 320 may record a high quality or HD item video in the same manner.

The Marketing and Listing Module 306 is configured to accept images from the Imaging Module 304 and control an automated item descriptor generator component 322 and an item pricing component 324. The item descriptor generator 322 and pricing 324 components provide an interactive tool to help the seller or system representative to identify whether an item is acceptable for online sale, and finds item related details such as average selling price, minimum and maximum sold price of similar items online, etc., to assist the seller with creating an appropriate and attractive item listing. Referring now to FIGS. 1 and 2, the listing may then be automatically posted to the online marketplaces of the seller's choice. In one embodiment, listings are automatically posted to eBay™.

The Fulfillment Center Module 308 is configured to control a packing component 326, a shipping component 328 and a tracking component 330. The fulfillment center handles all of the packaging and shipping and verifies that the item is delivered to the buyer. The packing application 326 selects the most cost effective packing materials for the seller's item. Packaging of the may be automated or performed by a system representative with packing material carried in the vehicle 344. The shipping application likewise evaluates shipping option and selects the most cost and time effective method for the seller's item and prints shipping labels for affixing to the packaged item. Shipping information is then input to the tracking component 330, enabling sellers and system representatives to track and account for sold items. Items are delivered to post offices or other shipping locations by the vehicle 342.

Electronic payment is accepted for sold items. When an item is sold and the buyer has acknowledged the item was received, the funds are transferred to a local currency if necessary, and made available to the seller through the Banking Center Module 310. In other embodiments, the system representative may pay the seller during a next visit.

The Banking Center Module 310 is configured to control a payment component 332 and a micro-loan component 334. The automated payment component performs accounting functions and makes funds for sold items available to the seller from centralized electronic accounts. In some embodiments, PayPal™ is used for electronic transfer of funds. The micro-loan component 334 may manage micro loan disbursements and payments through the centralized electronic account. The micro-loan component 334 may make micro-loans available to women for crafting and creating items for online sales, or other business ventures in under developed areas. The micro-loan component 334 may also cover relevant seller fees, which can then be automatically repaid when funds are disbursed to the seller's centralized electronic account.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

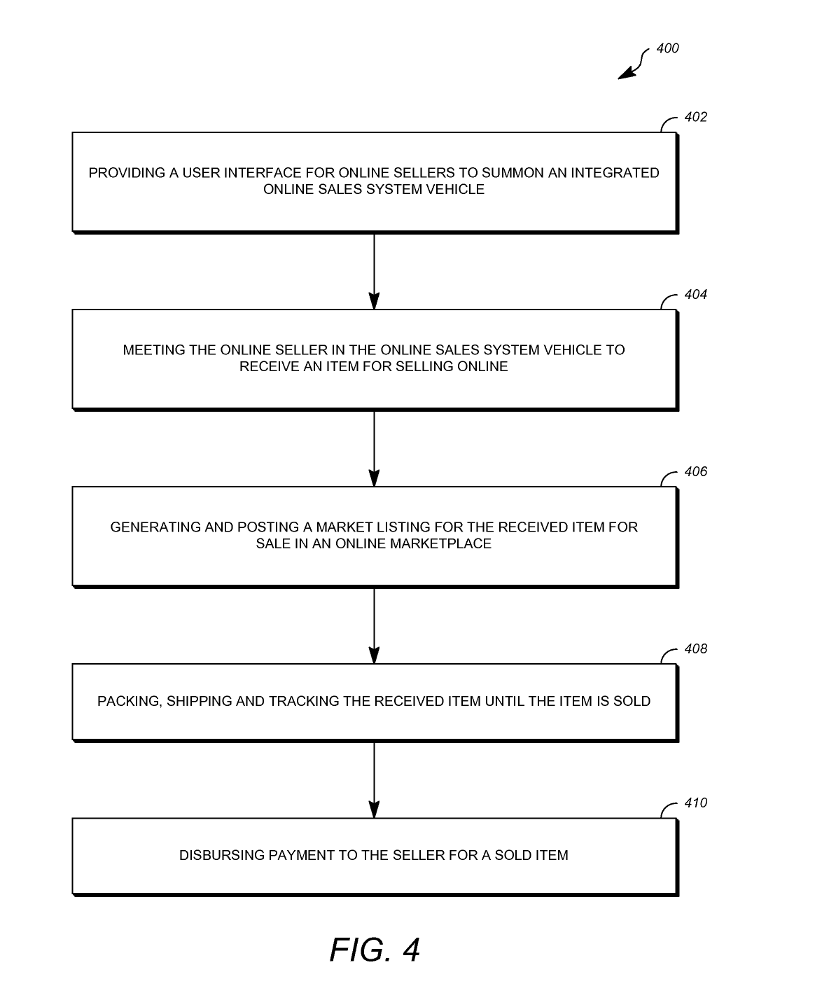

FIG. 4 shows a block diagram of a high level overview flow chart of Integrated Mobile Listing Service, according to some example embodiments. Operations in the method 400 may be performed by the networked system 202 using the marketplace application(s) 220 module of the application server 218 in conjunction with a data base(s) 226 and database server(s) 226 described above with respect to FIGS. 1 and 2. As shown in FIG. 4, the method 400 includes operations 402-410.

In operation 402, an online seller is provided with an interface to summon an integrated online sales system vehicle for meeting the online seller in the online sales system vehicle to receive an item for selling online in operation 404. In operation 406, a market listing for the received item for sale is generated and posted in an online marketplace. The item for sale is packed, shipped and tracked until the item is sold in operation 408 and payment is disbursed to the seller in operation 410.

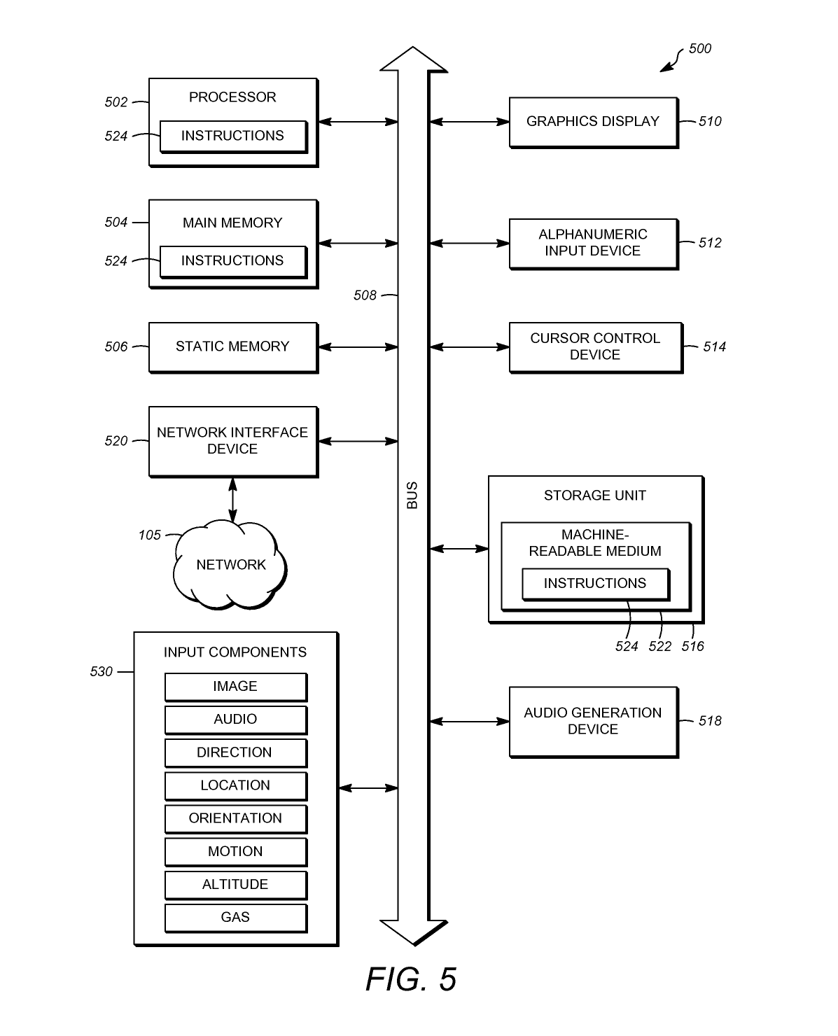

FIG. 5 is a block diagram illustrating components of a machine 500, according to some example embodiments, able to read instructions 524 from a machine-readable medium 522 (e.g., a machine-readable storage medium, a computer-readable storage medium, or any suitable combination thereof) and perform any one or more of the methodologies discussed herein, in whole or in part. Specifically, FIG. 5 shows the machine 500 in the example form of computer system within which the instructions 524 (e.g., software, a program, an application, an applet, an app, or other executable code) for causing the machine 500 to perform any one or more of the Integrated Mobile Listing Service module 302-310 methodologies discussed herein may be executed, in whole or in part. The machine(s) 500 may be integrated to the Integrated Mobile Listing Service vehicle 342. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a distributed (e.g., peer-to-peer) network environment.

The machine 500 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics, or video, display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or other pointing instrument), a storage, or drive, unit 516, an audio signal generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media (e.g., tangible and non-transitory machine-readable media). The instructions 524 may be transmitted or received over the network 105 via the network interface device 520. For example, the network interface device 520 may communicate the instructions 524 using any one or more transfer protocols (e.g., hypertext transfer protocol (HTTP)).

In some example embodiments, the machine 500 may be a fixed or portable computing device, such as a desktop computer, laptop computer, smart phone or tablet computer, and have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to send, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 105 (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

In one embodiment, A mobile integrated online sales system comprises a User Interface (UI) module for controlling an imaging module, a marketing and listing module, a fulfillment center module and a banking center module, an imaging module for capturing images of an item for online sale and providing input to marketing and listing module, a marketing and listing module for generating a complete online listing from the captured images of the item and providing input to a fulfillment center module, a fulfillment center module for packing, shipping and tracking the item, and providing input to a banking center module, and a banking center module for transferring payment funds.

Thus, a method and system for Integrated Mobile Listing Service have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. a mobile integrated online sales system comprising:
a wireless transceiver coupled to a mobile platform having a User Interface (UI) module;
a UI module configured to control an imaging module, a marketing and listing module, a fulfillment center module and a banking center module;
the imaging module configured to capture images of an item for online sale and provide input to the marketing and listing module;
the marketing and listing module configured to generate a complete online listing from the captured images of the item and provide input to a fulfillment center module;
the fulfillment center module configured to pack, ship and track the item, and provide input to a banking center module; and
the banking center module configured to transfer payment funds for an item sold online.

2. The mobile integrated online sales system of claim 1 further comprising a receptacle portal configured to receive an item for sale online.

3. The mobile integrated online sales system of claim 1 wherein the UI module further comprises a User Interface Application and a Mobile Application.

4. The mobile integrated online sales system of claim 1 wherein the UI module is configured to receive a summons or appointment request from a seller, in a transportation networked arrangement.

5. The mobile integrated online sales system of claim 1 wherein the imaging module further comprises a photograph upload component, still photography component and video component configured to capture the images.

6. The mobile integrated online sales system of claim 1 wherein the marketing and listing module further comprises an item descriptor generator component and an item pricing component configured to automatically generate an online item listing.

7. The mobile integrated online sales system of claim 1 wherein the fulfillment center module further comprises a packing component, a shipping component and a tracking component configured to manage delivery of an item sold online.

8. The mobile integrated online sales system of claim 1 wherein the banking center module further comprises a micro-loan component.

9. The mobile integrated online sales system of claim 1 further comprising a vehicle capable of traveling remote, rural and urban routes.

10. A computer-implemented method for mobile online sales comprising operations to:
provide a user interface for an online seller to summon or meet an integrated online sales system vehicle;
schedule a meeting with the online seller to receive an item for selling online;
generate and post a market listing for the received item for sale in an online marketplace until the item is sold;
arrange to pack, ship, and track the sold item until the sold item is delivered; and
disburse payment to the seller for the sold item.

11. The computer-implemented method for mobile online sales of claim 10 wherein Global Positioning System (GPS) routes and vehicle locations are published for notifying online sellers when a mobile online sales system vehicle is in their area and providing the ability for sellers to make an appointment or immediately summon the system vehicle.

12. The computer-implemented method for mobile online sales of claim 10 wherein the item is received for selling by being placed in a receptacle portal of a mobile system vehicle having integrated cameras for imaging the item in the receptacle portal.

13. The computer-implemented method for mobile online sales of claim 10 wherein a mobile online sales system vehicle travels remote, rural and urban routes.

14. The computer-implemented method for mobile online sales of claim 10 wherein payment is disbursed into an electronic account or paid to the seller in person by a mobile online sales system representative.

15. A non-transitory computer-readable storage medium storing a set of instructions that, when executed by a processor, cause the processor to perform operations, comprising:
controlling components of a mobile online sales system to assist a seller by:
operating imaging devices to photograph a seller's item;
generating and posting an online marketplace listing from the photographs;
arranging delivery of the listed item to a buyer; and
disbursing payment for the listed item to the seller.

16. The non-transitory computer-readable storage medium of claim 15 wherein the components that can be controlled comprise an imaging module, a marketing and listing module, a fulfillment center module and a banking center module.

17. The non-transitory computer-readable storage medium of claim 15 wherein the marketplace listing is automatically generated from the photographs of the items.

18. The non-transitory computer-readable storage medium of claim 15 wherein a marketplace listing price is generated according to sales prices of similar items previously sold in the online marketplace.

19. The non-transitory computer-readable storage medium of claim 15 wherein delivering the listed item comprises determining a lowest shipping cost.

20. The non-transitory computer-readable storage medium of claim 15 wherein sold items can be tracked by the seller.
